(19) United States
(12) Patent Application Publication
(10) Pub. No.: US 2007/0006716 A1
(43) Pub. Date: Jan. 11, 2007

(54) ON-BOARD ELECTRIC GUITAR TUNER

(76) Inventors: Ryan Salmond, Victoria, BC (CA); Ruaridh Angus Mackinnon, Victoria, BC (CA)

Correspondence Address: Ryan Salmond, 3954 Gordon Head Road, Victoria, BC, V8N3X2, CA

(21) Appl. No.: 11/456,109

(22) Filed: Jul. 7, 2006

Related U.S. Application Data
(60) Provisional application No. 60/697,186, filed on Jul. 7, 2005.

(51) Int. Cl. G10H 1/00

(52) U.S. Cl. 84/600

(57) ABSTRACT

A guitar tuner imbedded into an electric guitar, with the display hidden underneath a control knob. The display, a clear plastic cylinder containing a single character LCD and a tri-color LED, is revealed, and the activated, when said knob is pulled outwards from the guitar.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A SEQUENCE LISTING, A TABLE, OR A COMPUTER PROGRAM, LISTING COMPACT DISC APPENDIX

Not Applicable.

### BACKGROUND OF THE INVENTION

On-board electric guitar tuners have previously been described in U.S. Pat. No. 5,637,820 (Wittman, 1997) and U.S. Pat. No. 5,877,444 (Hine et al 1999).

### BRIEF SUMMARY OF THE INVENTION

This on-board electric guitar tuner is hidden in the guitar's body when not in use. In order to display the tuner, you pull the volume knob outwards from the guitar to reveal the display. The tuner automatically turns on when the display is pulled out into view.

### BRIEF DESCRIPTION OF THE SEVERAL VIEWS OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a transparent perspective view of the volume control in the retracted position.

FIG. 2 is a transparent perspective view of the volume control in the extended position.

FIG. 3 is a perspective view of a guitar with the guitar tuner constructed in accordance with the teachings of the present invention having the volume control in the extended position.

FIG. 4 is a perspective cutaway view of a guitar with the guitar tuner constructed in accordance with the teachings of the present invention.

FIG. 5 is a perspective cutaway view of a guitar with the guitar tuner constructed in accordance with the teachings of the present invention.

FIG. 6 is a perspective view of a guitar with the guitar tuner constructed in accordance with the teachings of the present invention in the retracted position.

FIG. 7 is a perspective cutaway view of a guitar with the guitar tuner constructed in accordance with the teachings of the present invention in the extended position.

### DETAILED DESCRIPTION OF THE PREFERRED EMBODIMENT

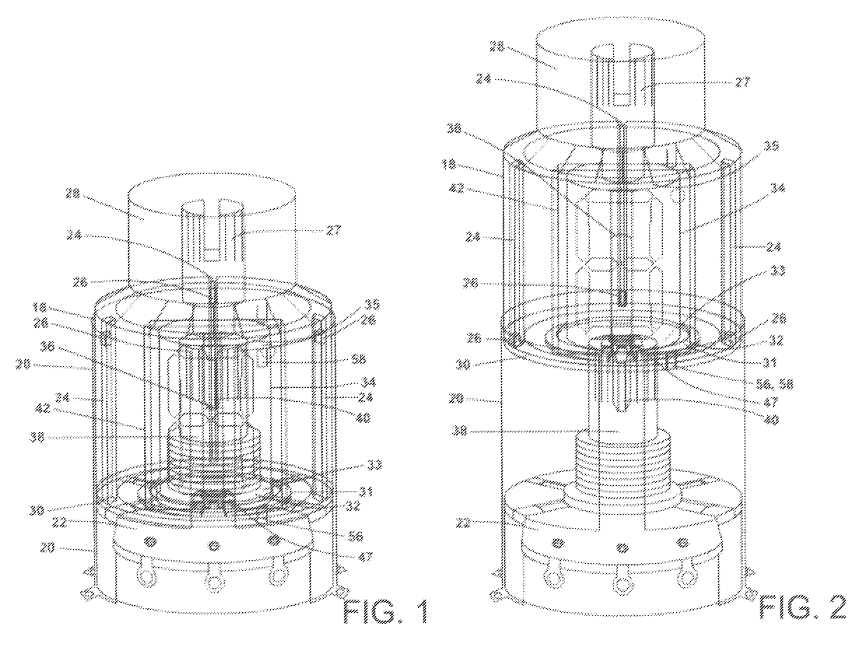

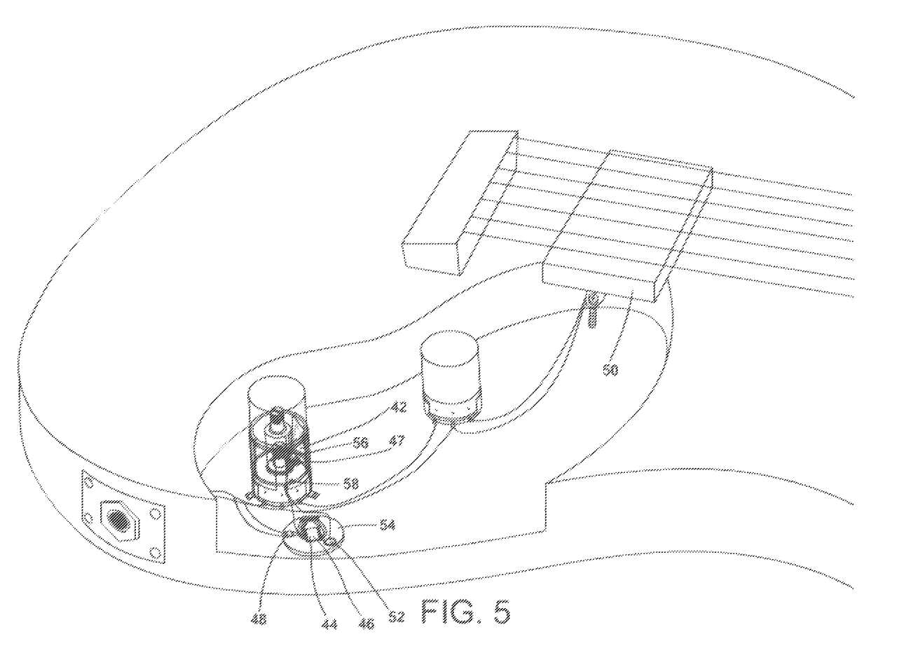

The preferred embodiment, a guitar tuner, will now be described with reference to FIGS. 1 through 7.

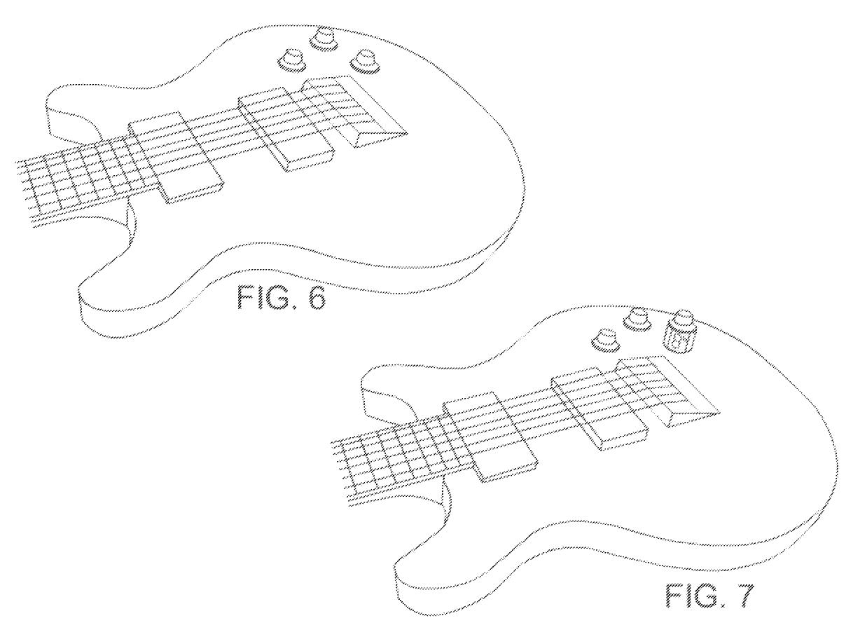

When you're using this tuner, the display is hidden in the body of the guitar, as shown in FIG. 6. You pull the volume knob outwards from the guitar to reveal the display, a clear cylinder with a bright LED screen, as shown in FIG. 7. The tuner automatically turns on when the display is pulled out into view. POwer, is supplied by a small battery, the same kind used in a watch. The tuner's electronic chip reads the signal straight from the pickups. Because of this, you can tune while plugged in to your amplifier, without bypassing your signal, meaning you can even check whether or not your in tune while you're playing. Once you've tuned the guitar you push the volume knob back in, hiding the tuner display inside the body of the guitar, and it turns off automatically. The volume knob rotates independently of the tuner display, which stays in place facing towards you, making volume fully adjustable at all times.

For simplicity and efficient use the tuner is chromatic. The LED screen shows the note your string is closest to. Colored LED lights illuminate the cylinder red, green, or blue to show you whether you are flat, in tune, or sharp respectively. The glow becomes more intense the closer you get to the displayed note.

One otherwise normal potentiometer is fitted with housing for the display shown in the diagrams, and the hole underneath this potentiometer's knob is made equal to the radius of the knob for the clear cylinder to slide through.

Mechanical Design:

Referring now to FIGS. 1 and 2, the clear cylinder (18) containing the LED display is placed in a metal housing that surrounds the volume potentiometer (22). The clear cylinder has three slots (24) cut lengthwise down its outer surface. These slots (24) slide over three metal points (26) fixed to the metal housing (20). This means the clear cylinder can move smoothly up and down but will not rotate with the volume knob (28) when the volume knob is adjusted.

Underneath the clear cylinder (18) is a washer (30) of equal circumference, held from underneath against the bottom of the clear cylinder (18) by a smaller washer (31) fixed to the bottom (32) of a narrower inner cylinder (34). This washer (31) comes in contact with the three metal points (26) attached to the metal housing (20) when the clear cylinder (18) is fully extended outward. This stops the cylinder (18) from extending any further.

The smaller, inner cylinder (34) mentioned earlier has a narrow opening (36) along its length, a closed top (35) and an open bottom (33). A fork-like piece (27) of the kind found in potentiometers, on top of which the volume knob (28) is fitted, is attached to the top of the inner cylinder. Because of this, the volume knob (28) and inner cylinder (34) rotate together as a single piece. Inside this inner cylinder (34), the potentiometer's fork-like top piece (38) is fitted with a metal protrusion (40). This protrusion extends through the inner cylinder's opening (36). When the volume knob (28) is turned the inner cylinder (34) turns with it, and the sides of the inner cylinder's narrow lengthwise opening (36) push the protrusion (40) attached to the potentiometer in the direction of rotation. This allows the volume to be adjusted whether the clear cylinder (18) is extended or retracted, while keeping the clear cylinder, to which the 7-segment LED display (42) is fixed, facing the player.

Electronic Design:

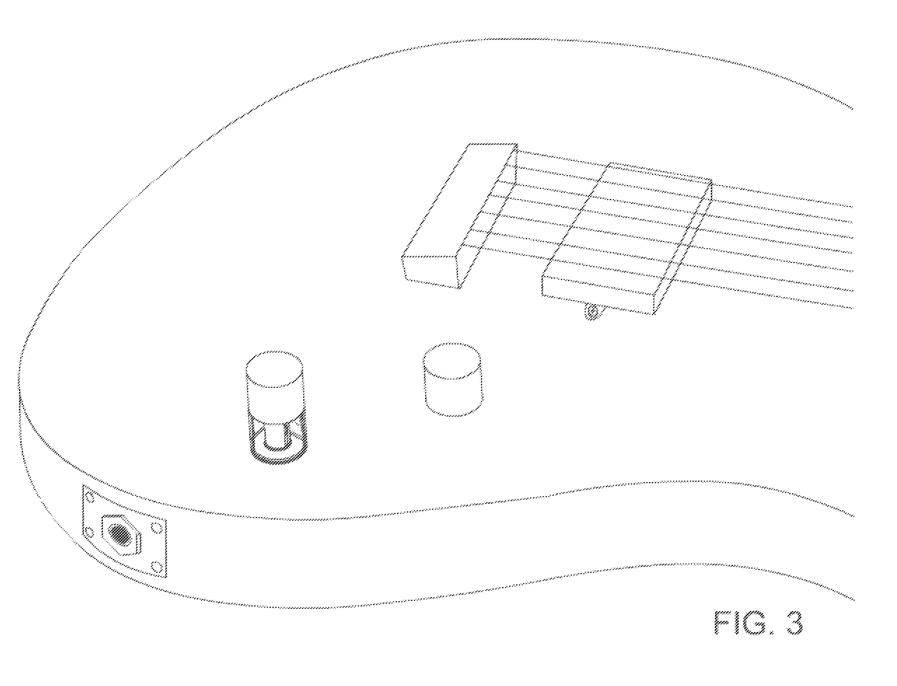

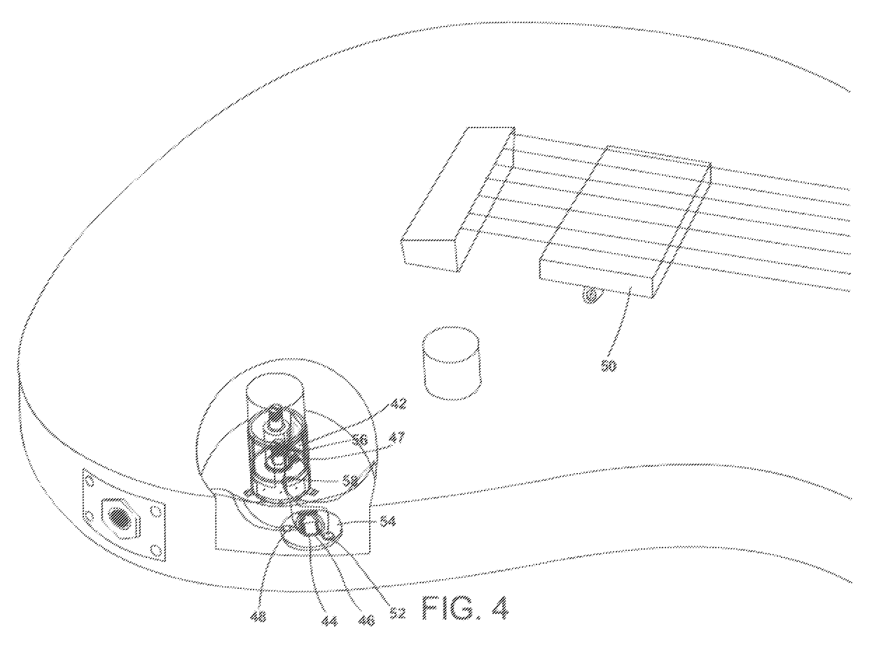

Referring now to FIG. 3 through 5, the electronic portion of this product consists of three main components: the display (42), the tuner (44), and the interface (46) between the two. In this design, a microcontroller acts as the interface and the tuner.

A low profile seven-segment surface mount display (42) indicates the note, while a Tri-color LED (47) indicates whether the string is flat, in tune, or sharp. And operational amplifier (48) amplifies the signal from the guitar pickups (50) providing a range of zero to five volts. This signal is then digitized using the Microcontroller's 10 bit Analog to Digital converter. An FFT function determines the peak frequency component of the signal and the nearest note to this frequency is displayed. The frequency is compared to the ideal frequency for the specific note and the tuning tri-color LED (47) indicates whether the string is flat, in tune, or sharp. This process is repeated at least 30 times per second so that the user does not experience any delay during tuning. The power supply (52) is either an onboard 5-volt watch type battery, or the 9-volt battery found in guitars with active electronics. Should the 9-volt battery be used, a dc/dc voltage converter will be necessary to supply the microcontroller with 5 volts.

To save power, the tuner is only connected to the supply when the tuner is being operated. The tuner is activated when two metal contact points (56, 58), one on the stationary metal housing (20), and one on the moving clear cylinder (18) come in contact with each other, when the display cylinder is fully extended outward. Alternatively the microprocessor could go into a low power mode with alterations to the design. In addition, the LED's (47) can be pulsed at 60 Hz for further power savings.

The PCB board (54) can be built to fit under the tuner to save space if so desired, otherwise the board can be mounted anywhere there is room inside the guitar. The size of the board (54) can be reduced by using the surface mount devices and a multilayer board.

The embodiments of the invention in which an exclusive property or privilege is claimed are defined as follows:

1. In an electric guitar, a tuner with display located underneath, in, or on any control knob.

2. In an instrument tuner's display, lights of different colours used to represent sharp, in tune, or flat, in changing intensities relative to the measured signal's proximity to the desired note.
